(19) United States
(12) Patent Application Publication
(10) Pub. No.: US 2018/0218318 A1
(43) Pub. Date: Aug. 2, 2018

(54) METHOD AND APPARATUS FOR GENERATING A DYNAMIC ENVIRONMENTAL PROFILE FOR TRANSPORT OF CARGO

(71) Applicant: Nokia Technologies Oy, Espoo (FI)

(72) Inventors: Henri PASSILA, Espoo (FI); Lea MYYRYLÄINEN, Espoo (FI); Juha UOLA, TAMPERE (FI); Pekka REIJULA, Pirkkala (FI); Jari VAINIKKA, Vantaa (FI)

(21) Appl. No.: 15/745,803

(22) PCT Filed: Jul. 30, 2015
(86) PCT No.: PCT/IB2015/055797

§ 371 Date: Jan. 18, 2018

(51) Int. Cl. G06Q 10/08

(52) U.S. Cl. CPC G06Q 10/0832; H04W 4/80; G06Q 10/0833; G06Q 10/0838

(57) ABSTRACT

A method is provided for generating a dynamic environmental profile for transport of cargo. In particular, example methods may include receiving cargo information comprising a cargo type, receiving cargo transport history, receiving a transport plan, and calculating, based on the cargo information, the cargo transport history, and the transport plan, a transport itinerary comprising environmental control instructions for a remaining portion of the transport plan. The cargo information may include an environmental profile. An environmental profile may be determined in response to receiving the cargo information. The cargo transport history may include an environmental profile of the cargo beginning at the origin of the cargo.

### TECHNICAL FIELD

Example embodiments of the present invention relate generally to the transportation of cargo having specific environmental requirements, and more particularly, to generating a dynamic environmental profile for the transport of cargo based on cargo type and transportation history.

### BACKGROUND

The modern era has brought about increases in efficiency and productivity for virtually all industries, ranging from agriculture to manufacturing to customer services. One substantial factor in the increase in efficiency and productivity is the scale of production of many consumer goods. For example, an assembly-line type of manufacture of an article may be considerably more efficient than a traditional hand-fabricated, manual type of manufacture. However, assembly-line manufacturing does not necessarily scale well, such that large manufacturing facilities are required to facilitate such manufacture. These large facilities may be too large and costly to introduce in substantial geographic dispersion such that manufacturing of many goods often takes place at a central facility, and the finished product of manufacture is transported from the manufacturing facility to the customer.

Agriculture has experienced a similar change in that “factory farming” and large-scale crop growing operations have largely replaced smaller, more geographically dispersed local farms. The advent of machinery that can harvest large amounts of crops, or facilities that can process large amounts of animal byproducts has led to the centralization of agriculture in certain regions. Thus, transportation of agricultural goods in a timely manner has become an important operation. It is often necessary to control the environment in which products are transported, whether the products require refrigeration, such as with meat, or products may require insulation from a cold ambient environment, such as with bottled or canned goods.

### BRIEF SUMMARY

In general, example embodiments of the present invention provide a method and apparatus, and computer program product for generating a dynamic environmental profile for transport of cargo. According to an apparatus of an example embodiment, the apparatus may include at least one processor and at least one memory including computer program code. The at least one memory and the computer program code being configured to, with the at least one processor, cause the apparatus to: receive cargo information comprising a cargo type; receive cargo transport history; receive a transport plan; and calculate, based on the cargo information, the cargo transport history, and the transport plan, a transport itinerary comprising environmental control instructions for a remaining portion of the transport plan. The cargo information may include an environmental profile. The apparatus may be caused to determine an environmental profile in response to receiving the cargo information. The cargo transport history may include an environmental history of the cargo beginning at the origin of the cargo.

According to some embodiments, the apparatus may be caused to calculate future environmental requirements including environmental control instructions for the transport itinerary based on the cargo transport history environmental history. The transport itinerary may include a plurality of phases of transportation, and each of the plurality of phases of transportation may include environmental control instructions, where environmental control instructions differ between at least two phases of the plurality of phases of transportation. Each of the plurality of phases of transportation may be associated with environmental control limitations, where the environmental control limitations of a first phase of transportation may influence the environmental control instructions for a second phase of transportation.

Embodiments provided herein may include a method including: receiving cargo information comprising a cargo type; receiving cargo transport history; receiving a transport plan; and calculating, based on the cargo information, the cargo transport history, and the transport plan, a transport itinerary comprising environmental control instructions for a remaining portion of the transport plan. The cargo information may include an environmental profile. An environmental profile may be determined in response to receiving the cargo information. The cargo transport history may include an environmental profile of the cargo beginning at the origin of the cargo.

According to some embodiments, methods may include calculating future environmental requirements including environmental control instructions for the transport itinerary based on the cargo transport history environmental profile. The transport itinerary may include a plurality of phase of transportation, and each of the plurality of phases of transportation may include environmental control instructions, where environmental control instructions differ between at least two phases of the plurality of phases of transportation. Each of the plurality of phases of transportation may be associated with environmental control limitations, where the environmental control limitations of a first phase of transportation may influence the environmental control instructions for a second phase of transportation.

Embodiments may include a computer program product including at least one non-transitory computer-readable storage medium having computer-executable program code instructions stored therein. The computer-executable program code instructions may include: program code instructions for receiving cargo information comprising a cargo type; program code instructions for receiving cargo transport history; program code instructions for receiving a transport plan; and program code instructions for calculating, based on the cargo information, the cargo transport history, and the transport plan, a transport itinerary comprising environmental control instructions for a remaining portion of the transport plan. The cargo information may include an environmental profile. Optionally, the computer program product may include program code instructions to determine an environmental profile in response to receiving the cargo information. The cargo transport history may include an environmental history of the cargo beginning at the origin of the cargo.

According to some embodiments, the computer program product may include program code instructions for calculating future environmental requirements including environmental control instructions for the transport itinerary based on the cargo transport history environmental history. The transport itinerary may include a plurality of phases of transportation, where each of the plurality of phases of transportation may include environmental control instructions, where environmental control instructions differ between at least two phases of the plurality of phases of transportation.

Embodiments provided herein may include an apparatus including: means for receiving cargo information comprising a cargo type; means for receiving cargo transport history; means for receiving a transport plan; and means for calculating, based on the cargo information, the cargo transport history, and the transport plan, a transport itinerary comprising environmental control instructions for a remaining portion of the transport plan. The cargo information may include an environmental profile. An environmental profile may be determined in response to receiving the cargo information. The cargo transport history may include an environmental profile of the cargo beginning at the origin of the cargo.

According to some embodiments, the apparatus may include means for calculating future environmental requirements including environmental control instructions for the transport itinerary based on the cargo transport history environmental profile. The transport itinerary may include a plurality of phase of transportation, and each of the plurality of phases of transportation may include environmental control instructions, where environmental control instructions differ between at least two phases of the plurality of phases of transportation. Each of the plurality of phases of transportation may be associated with environmental control limitations, where the environmental control limitations of a first phase of transportation may influence the environmental control instructions for a second phase of transportation.

### BRIEF DESCRIPTION OF THE DRAWINGS

Having thus described example embodiments of the invention in general terms, reference will now be made to the accompanying drawings, which are not necessarily drawn to scale, and wherein:

FIG. 1 illustrates a mobile device and transport system in accordance with an example embodiment of the present invention;

FIG. 2 is a schematic block diagram of a mobile device according to an example embodiment of the present invention;

FIG. 3 depicts an article of cargo comprising a mobile device according to an example embodiment of the present invention;

FIG. 4 is a schematic block diagram of a transport system in accordance with an example embodiment of the present invention;

FIG. 5 illustrates at least a portion of cargo information and at least a portion of a transport plan according to an example embodiment of the present invention;

FIG. 6 illustrates a transportation plan and temperature timeline of the transportation plan according to an example embodiment of the present invention;

FIG. 7 illustrates another transportation plan and temperature timeline of the transportation plan according to another example embodiment of the present invention; and

FIG. 8 is a flowchart of a method for determining a transportation plan according to an example embodiment of the present invention.

### DETAILED DESCRIPTION

Some example embodiments of the present invention will now be described more fully hereinafter with reference to the accompanying drawings, in which some, but not all embodiments of the invention are shown. Indeed, various embodiments of the invention may be embodied in many different forms and should not be construed as limited to the example embodiments set forth herein; rather, these example embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with embodiments of the present invention.

Additionally, as used herein, the term ‘circuitry’ refers to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

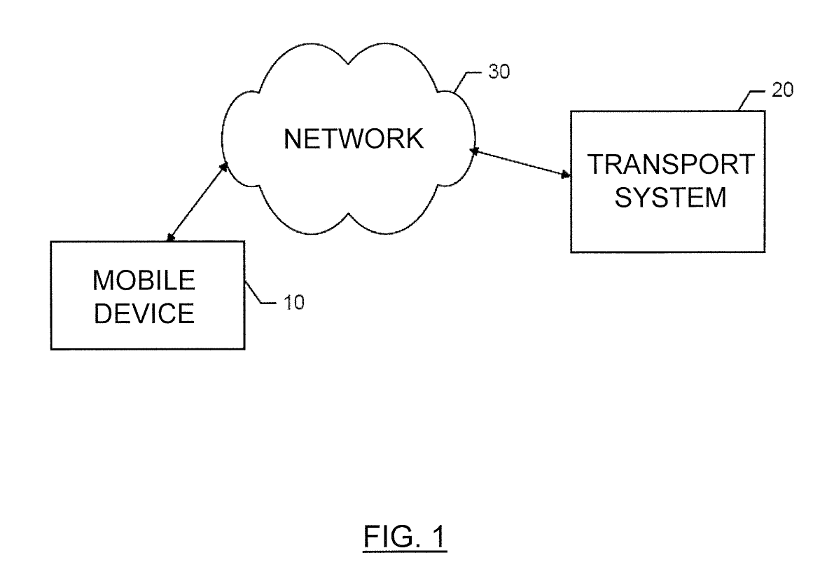

Example embodiments described herein may include a mobile device which is operable on a network for communicating with a system for coordinating the transportation of cargo and for generating a dynamic environmental profile for transport of cargo. The mobile device 10 may be in communication with a system 20 through a session supported by a network 30, as shown in FIG. 1. The network may include a collection of various different nodes, devices or functions that may be in communication with each other via corresponding wired and/or wireless interfaces or in ad-hoc networks such as those functioning over Bluetooth®. As such, FIG. 1 should be understood to be an example of a broad view of certain elements of a system that may incorporate example embodiments of the present invention and not an all inclusive or detailed view of the system or the network 30. Although not necessary, in some example embodiments, the network 30 may be capable of supporting communication in accordance with any one or more of a number of first-generation (1G), second-generation (2.G), 2.5G, third-generation (3G), 3.5G, 3.9G, fourth-generation (4G) mobile communication protocols and/or the like.

One or more communication terminals such as the mobile device 10 and the transport system 20 may be in communication with each other via the network 30 and each may include an antenna or antennas for transmitting signals to and for receiving signals from a base site, which could be, for example a base station that is part of one or more cellular or mobile networks or an access point that may be coupled to a data network, such as a local area network (LAN), a metropolitan area network (MAN), and/or a wide area network (WAN), such as the Internet. In turn, other devices (for example, personal computers, server computers or the like) may be coupled to the mobile device 10 and the transport system 20 via the network 30. By directly or indirectly connecting the mobile device 10 and the second mobile terminal 20 and other devices to the network 30, the mobile device 10 and the transport system 20 may be enabled to communicate with the other devices or each other, for example, according to numerous communication protocols including Hypertext Transfer Protocol (HTTP) and/or the like, to thereby carry out various communication or other functions of the mobile device 10 and the transport system 20, respectively.

In example embodiments, the transport system 20 may include one or more mobile or fixed communication devices. Thus, for example, the transport system 20 could be, or be substituted by, any of personal computers (PCs), personal digital assistants (PDAs), wireless telephones, desktop computers, laptop computers, mobile computers, cameras, video recorders, audio/video players, positioning devices, game devices, television devices, radio devices, or various other devices or combinations thereof.

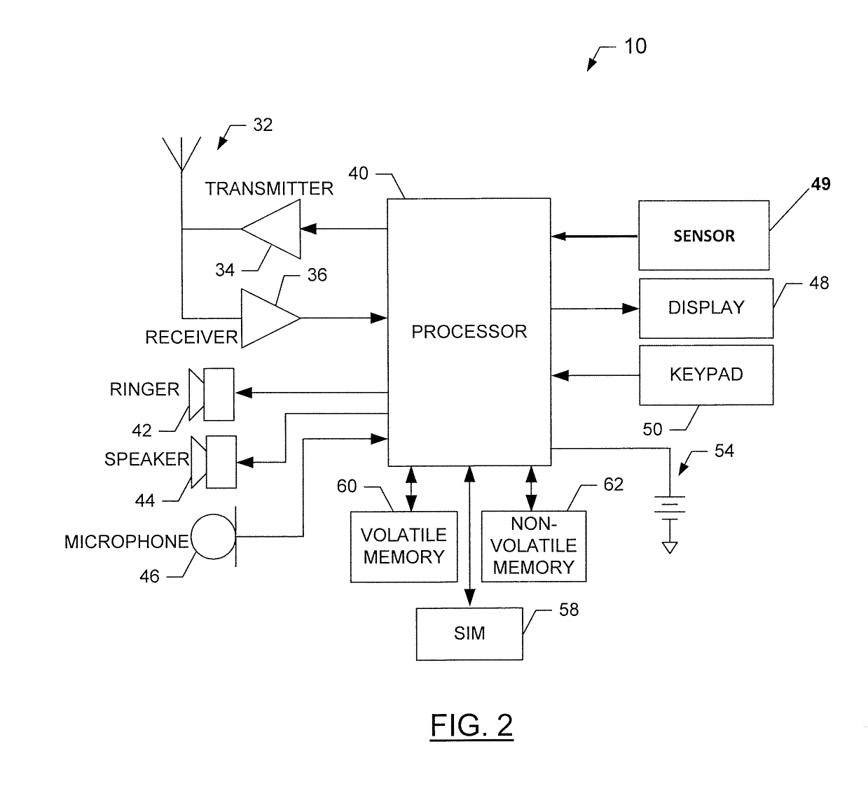

Although the mobile device 10 may be configured in various manners, one example of a mobile device that could benefit from embodiments of the invention is depicted in the block diagram of FIG. 2. While several embodiments of the mobile device may be illustrated and hereinafter described for purposes of example, other types of mobile devices, such as portable digital assistants (PDAs), pagers, mobile televisions, gaming devices, all types of computers (for example, laptops or mobile computers), cameras, audio/video players, radio, global positioning system (GPS) devices, or any combination of the aforementioned, and other types of communication devices, may employ embodiments of the present invention. One such example communication device may include a cargo-mounted mobile device for data gathering, as will be described with respect to the example embodiments detailed below and illustrated in the figures. As described, the mobile device may include various means for performing one or more functions in accordance with embodiments of the present invention, including those more particularly shown and described herein. It should be understood, however, that a mobile device may include alternative means for performing one or more like functions, without departing from the spirit and scope of the present invention.

The mobile device 10 may, in some embodiments, be a computing device configured to employ an example embodiment of the present invention. However, in some embodiments, the mobile device may be embodied as a chip or chipset. In other words, the mobile terminal may comprise one or more physical packages (for example, chips) including materials, components and/or wires on a structural assembly (for example, a baseboard). The structural assembly may provide physical strength, conservation of size, and/or limitation of electrical interaction for component circuitry included thereon. The mobile device may therefore, in some cases, be configured to implement an embodiment of the present invention on a single chip or as a single “system on a chip.” As such, in some cases, a chip or chipset may constitute means for performing one or more operations for providing the functionalities described herein.

The mobile device 10 illustrated in FIG. 2 may include an antenna 32 (or multiple antennas) in operable communication with a transmitter 34 and a receiver 36. The mobile device may further include a processor 40 that provides signals to and receives signals from the transmitter and receiver, respectively. The signals may include signaling information in accordance with the air interface standard of the applicable cellular system, and/or may also include data corresponding to user speech, received data and/or user generated data. In this regard, the mobile device may be capable of operating with one or more air interface standards, communication protocols, modulation types, and access types. By way of illustration, the mobile device may be capable of operating in accordance with any of a number of first, second, third and/or fourth-generation communication protocols or the like. For example, the mobile device may be capable of operating in accordance with second-generation (2G) wireless communication protocols IS-136, GSM and IS-95, or with third-generation (3G) wireless communication protocols, such as UMTS, CDMA2000, wideband CDMA (WCDMA) and time division-synchronous CDMA (TD-SCDMA), with 3.9G wireless communication protocols such as E-UTRAN (evolved- UMTS terrestrial radio access network), with fourth-generation (4G) wireless communication protocols or the like.

It is understood that the apparatus may include circuitry implementing, among others, audio and logic functions of the mobile device 10. The processor may be embodied in a number of different ways. For example, the processor may be embodied as various processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like), a hardware accelerator, and/or the like.

In an example embodiment, the processor 40 may be configured to execute instructions stored in the memory device 60 or otherwise accessible to the processor 40. Alternatively or additionally, the processor 40 may be configured to execute hard coded functionality. As such, whether configured by hardware or software methods, or by a combination thereof, the processor 40 may represent an entity (for example, physically embodied in circuitry) capable of performing operations according to an embodiment of the present invention while configured accordingly. Thus, for example, when the processor 40 is embodied as an ASIC, FPGA or the like, the processor 40 may be specifically configured hardware for conducting the operations described herein. Alternatively, as another example, when the processor 40 is embodied as an executor of software instructions, the instructions may specifically configure the processor 40 to perform the algorithms and/or operations described herein when the instructions are executed. However, in some cases, the processor 40 may be a processor of a specific device (for example, a mobile device or network device) adapted for employing an embodiment of the present invention by further configuration of the processor 40 by instructions for performing the algorithms and/or operations described herein. The processor 40 may include, among other things, a clock, an arithmetic logic unit (ALU) and logic gates configured to support operation of the processor 40.

The mobile device 10 may also comprise a user interface including an output device such as an earphone or speaker 44, a ringer 42, a microphone 46, a display 48, and a user input interface, which may be coupled to the processor 40. The user input interface, which allows the mobile terminal to receive data, may include any of a number of devices allowing the mobile terminal to receive data, such as a keypad 50, a touch sensitive display or other input device. In embodiments including the keypad, the keypad may include numeric (0-9) and related keys (#, *), and other hard and soft keys used for operating the mobile terminal 10. Alternatively, the keypad may include a conventional QWERTY keypad arrangement. The keypad may also include various soft keys with associated functions. In addition, or alternatively, the mobile terminal may include an interface device such as a joystick or other user input interface. The mobile terminal may further include a battery 54, such as a vibrating battery pack, for powering various circuits that are used to operate the mobile device, as well as optionally providing mechanical vibration as a detectable output. The mobile device 10 may also include a sensor 49, such as an accelerometer, motion sensor/detector, temperature sensor, or other environmental sensor to provide input to the processor indicative of a condition or stimulus of the mobile device 10, or the cargo to which the mobile device may be attached and/or associated.

The mobile device 10 may further include a user identity module (UIM) 58, which may generically be referred to as a smart card. The UIM may be a memory device having a processor built in. The UIM may include, for example, a subscriber identity module (SIM), a universal integrated circuit card (UICC), a universal subscriber identity module (USIM), a removable user identity module (R-UIM), or any other smart card. The UIM may store information elements related to a mobile subscriber. In addition to the UIM, the mobile device may be equipped with memory. For example, the mobile device may include volatile memory 60, such as volatile Random Access Memory (RAM) including a cache area for the temporary storage of data. The mobile device may also include other non-volatile memory 62, which may be embedded and/or may be removable. The non-volatile memory may additionally or alternatively comprise an electrically erasable programmable read only memory (EEPROM), flash memory or the like. The memories may store any of a number of pieces of information, and data, used by the mobile device to implement the functions of the mobile device. For example, the memories may include an identifier, such as an international mobile equipment identification (IMEI) code, capable of uniquely identifying the mobile device. Furthermore, the memories may store instructions for determining cell id information. Specifically, the memories may store an application program for execution by the processor 40, which determines an identity of the current cell, for example, cell id identity or cell id information, with which the mobile device is in communication.

While the above described embodiments of a mobile device 10 may include features that go well beyond the necessary components to provide functionality of fundamental concept described herein, mobile devices 10 capable of performing the basic functions of cargo monitoring and communications may be implemented in considerably more basic devices, such as radio frequency identification (RFID) tags, Bluetooth™ enabled tags, or other tags capable of monitoring environmental conditions through appropriate sensors and comprising communications capabilities. While tags configured to record environmental conditions and report the experienced conditions may be used in conjunction with transport systems as described herein, embodiments incorporating greater functionality into the mobile devices 10 used to monitor cargo, such as that illustrated in FIG. 2, may be capable of performing the functions of the transport system 20 within the mobile device 10. As such, the mobile device 10 may take on many forms in dependence on the configuration of the system and the desired cargo environmental control autonomy.

In general, example embodiments described herein provide a method for generating a dynamic environmental profile for transport of cargo. For example, cargo information may be received including a cargo type. An environmental profile may be determined based on the cargo type, where the environmental profile may include temperatures, temperature ranges, humidity, humidity ranges, duration at any particular temperature and/or humidity, ultraviolet exposure limits or requirements, impact thresholds or limits, barometric pressure ranges or requirements, etc. In general, an environmental profile specified for any particular cargo may include information related to any potential environmental factors that may affect the cargo in any manner.

According to some embodiments, agricultural cargo may have specific temperature and humidity requirements for transport. For example, bananas are a fruit that are very sensitive to temperatures. Chilling of bananas below approximately 56° F. (13° C.) for several hours may cause the peel of the fruit to take on a brown or dull-gray appearance, making the fruit unsuitable for sale to consumers. Bananas can also be adversely affected by elevated temperatures, such as when temperatures exceed 65° F. (18° C.) for extended periods, and take on a brown or orange appearance to the peel. In either case, the shelf life of the fruit may be shortened, and the value of the fruit dramatically changed through transport outside of the recommended temperature ranges. Further, it is recommended that bananas be stored with a relative humidity ranging from 80-95% Therefore it is important to transport bananas with a relatively strict environmental profile in order to maintain the value of the cargo.

While the above-noted example describes the storage of bananas, various other types of cargo require specific environmental profiles to be safely transported while maintaining the commercial value of the cargo. For example, meat products may have very strict temperature control requirements during shipping to ensure the safety of the meat upon arrival at a destination. Cargo comprising electronic goods (for example, televisions, computers, etc.) may have environmental profile requirements that limit temperature and humidity, while also limiting an impact force (acceleration thresholds) for those products. Medications may have specific temperature, humidity, and light exposure requirements as part of their environmental profile for transport in order to maintain efficacy. In each of these cases, the value of the shipped cargo may be heavily dependent upon proper maintenance of the environmental conditions of the cargo.

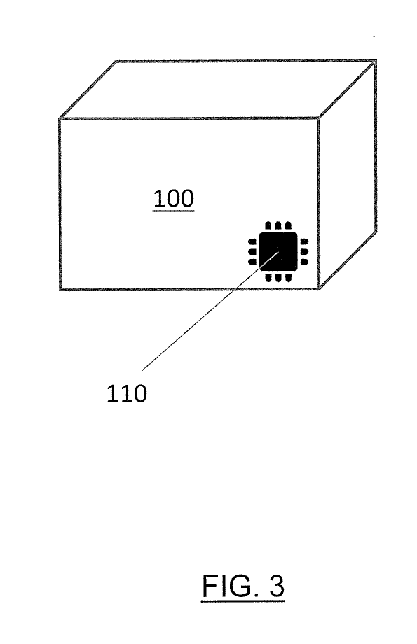

According to example embodiments described herein, a shipment containing cargo may be prepared at an origin by a shipper to be transported to a destination. FIG. 3 illustrates an example embodiment in which the cargo 100 includes a device 110, which may be, for example, mobile device 10 of FIG. 1 or 2. The device 110 may be programed with the cargo information related to the cargo 100 to which it is associated. The cargo information may include the cargo type, information about the origin and/or destination, and possibly information about environmental requirements of the cargo. According to some embodiments, the device 110 may further include a transport plan that includes information regarding various phases of the transportation route from the origin to the destination, which may include multiple phases of transport through multiple types of vehicles and environments. Optionally, the device 110 may have a unique identifier, and the transport plan may be generated and/or stored remotely, such as at transport system 20.

The cargo 100 may be shipped from an origin to a destination in a single vehicle, with a single environment that is well controlled. However, many shipments of cargo take multiple phases in which vehicles may be changed and environmental controls may be inconsistent. For example, a shipment of bananas may begin at an origin in Ecuador where the bananas may be grown, with a destination of St. Louis, Miss. in the United States. The banana cargo may travel by truck from the banana plantation in Ecuador to a port, where the banana cargo may be transferred to a ship for transport across water. The ship may arrive in the Port of New Orleans, where the banana cargo may be loaded to a train. The train may carry the banana cargo from the Port of New Orleans to a train depot in St. Louis, Miss. Upon arrival at the train depot, the banana cargo may be loaded onto a delivery truck which may deliver the banana cargo to a grocery store for sale to a consumer, or to a warehouse where the banana cargo will await transport to a grocery store. This transportation journey includes multiple phases, consisting of truck transport, boat transport, train transport, and truck transport again. In each phase, the environment of the cargo may be controlled to maximize the shelf-life of the cargo.

Example embodiments described herein may provide optimal environmental parameters for environment controlled transport during multiple transport phases of cargo's journey from origin to destination. Embodiments may use cargo information to determine the optimum environmental control parameters for cargo throughout its journey, and embodiments may further be configured to adjust and plan environmental control parameters for remaining transportation phases based on the history of transportation phases that have been completed or are in progress.

Provided herein is a system for secure, dynamically configurable sensor-based monitoring of cargo that can be used for cargo throughout multiple phases of transportation from origin to destination. Systems may include multiple sensor devices, such as sensor 49 of mobile device 10 of FIG. 2, which may include a Bluetooth low-energy sensor tag, RFID sensor tag, or other sensor coupled to a communication device in order to monitor environmental conditions of the cargo. The transport system 20 may include a back-end system for recording sensor data, storing transport parameters, and connecting the cargo information to a database. While some embodiments illustrated herein describe a system where the mobile device 10 may be used primarily as a remote monitor for the cargo, according to some embodiments, the mobile device 10 may incorporate all or some of the features of the transport system 20 such that the cargo monitoring can be performed at the cargo through the associated mobile device 10.

According to an example embodiment, the cargo 100 may begin a transport journey at an origin. The cargo 100 may include mobile device 110 associated therewith, which may optionally be attached to the cargo 100 or otherwise transported with the cargo. The mobile device 110 may be programmed with cargo information at the origin, which may include cargo type, for example. Cargo type may include whether the cargo is produce, such as bananas, apples, etc., animal products such as meat or milk, or other cargo, such as one or more televisions etc. The mobile device 110 may also include a unique identification of the cargo, such as a tracking number.

The mobile device 110 may be in communication, for example, via network 30, with a transport system 20. Optionally, the mobile device 110 may perform the functions of the transport system 20; however, the mobile device 110 may not be sufficiently sophisticated to perform all of the functions of the transport system 20 in order to keep the mobile device as a low-cost tracking device. However, as technology evolves, it is possible that the mobile device 110 includes all of the functionality necessary to perform each of the functions of the transport system independently while communicating with ancillary devices over the network to provide information regarding the cargo and the transportation plan as described herein.

The transport system 20 may receive the cargo information from the mobile device 110 or from a device that has programmed the mobile device 110 with the cargo information. The transport system 20 may identify the cargo type from the cargo information and the tracking number of the mobile device 110. The mobile device 110 may also be programmed with the origin and/or destination of the cargo; however, the transport system 20 may be configured to store origin and destination information relative to the unique tracking number associated with the mobile device 110. The transport system 20 may reference a database comprising cargo types and their necessary handling information, such as environmental requirements or an environmental profile for the cargo during transport. This database may map cargo types with their recommended or necessary handling information. As described above, certain types of cargo may require very specific environmental conditions during transport.

In response to receiving the environmental profile for the cargo and the origin/destination, the transport system 20 may develop a transport plan for getting the cargo 100 from the origin to the destination. The transport plan may include multiple phases of transport, where each phase of transport is defined as a portion of the journey with at least one of a different mode of transportation (for example, automobile, truck, train, boat, airplane), a different container for the cargo (for example, a cargo van, a shipping container, or warehouse), or different environmental controls (for example, a refrigerated truck or a climate controlled warehouse). While warehousing of goods is typically not considered a phase of transportation, as described herein, a portion of a journey in which cargo may be temporarily stored at a warehouse is considered a phase of transport as it is a phase between the origin and destination that has distinguishing characteristics as described above.

The transport plan generated by the transport system 20 may define each phase of the journey and define the environmental controls that are to be implemented at each phase. This transport plan may include a transport itinerary defining each phase, mode of transportation, and the environmental requirements of each transport phase. Once this transportation plan and itinerary are developed, the cargo 100 may be ready for transport.

While a transport plan, including multiple phases of transport and desired environmental conditions for each phase of the transport may be generated at the origin of the cargo, the actual transport journey may not go exactly as planned. Thus, embodiments described herein provide a method of dynamically adjusting the transport plan throughout the transport journey.

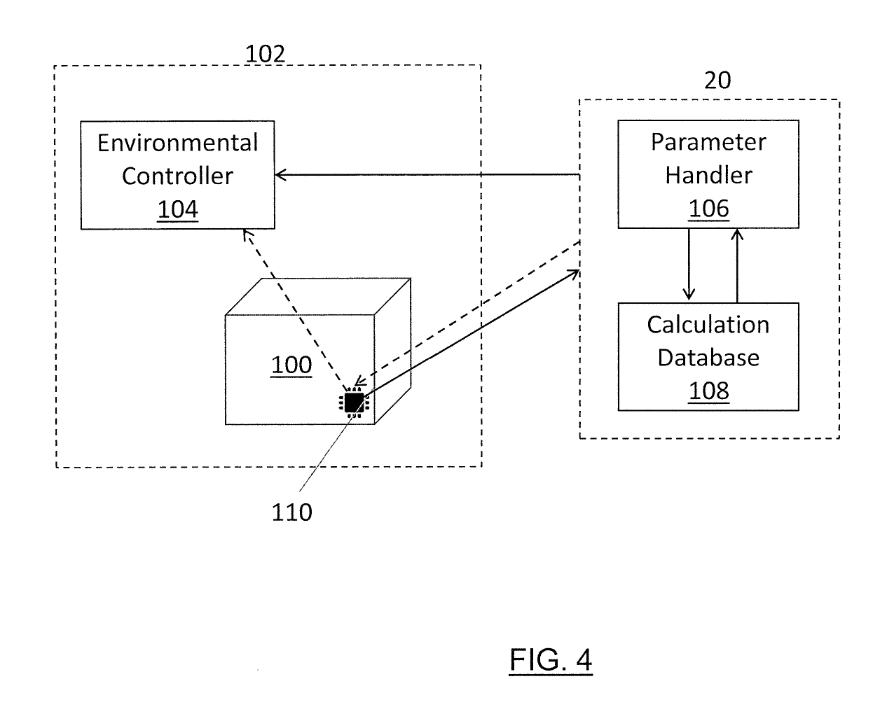

FIG. 4 illustrates an example embodiment of a system implementing embodiments of the invention described herein during a transport journey. As shown, the cargo 100 includes device 110 to at least record environmental conditions. The cargo 100 may be disposed in a vehicle or container 102 that includes an environmental controller 104 configured to adjust the environmental conditions of the vehicle or container 102. The device 110 of the cargo 100 may provide cargo type and cargo environment history to parameter handler 106 of the transport system 20. The cargo environment history may include a timeline of temperature, humidity, UV exposure, etc., of the cargo since the origin. The parameter handler 106 may communicate the cargo type and environmental history to the calculation database 108. The parameter handler 106 may be embodied, in some example embodiments, by processor 40 or other processing circuitry. Similarly, the calculation database 108 may be embodied by non-volatile memory 62 or the like. The calculation database 108 may, based on the cargo type, determine the appropriate cargo type environmental profile for the transportation journey. This environmental profile may include the minimum/maximum temperatures allowed, minimum/maximum humidity allowed, and any exceptions to the allowable parameters (for example, the cargo may be allowed to spend up to a certain amount of time outside of an allowed temperature window). The parameter handler 106 may further communicate the environmental history of the cargo to the calculation database. The history may include relevant events, such as periods without environmental monitoring. The history may be more granular (for example, high sample rates) for certain periods, and less granular (for example, low sample rates) for other portions of the history. The environmental history may optionally be updated from an external service, such as an environmental profile of a vehicle that transported the cargo along a prior phase of the transport plan. This external history may be compared against the measured history at the device 110, and may be used to fill in any gaps, or to validate the accuracy of the device 110 or the vehicle environmental control.

The calculation database 108 may consider the environmental history of the cargo and the environmental profile associated with the cargo type to calculate or revise the transport plan for the remaining phases of the journey. The calculation may take into consideration the environmental control capabilities of the vehicles to be used for future phases of the transport plan, and any phases of the transport plan for which environmental control is unknown. Based on this information, the calculation database may device a transport itinerary that includes desired environmental settings for each remaining phase of the journey. The revised transport plan may be communicated from the transport system 20 to the environmental controller 104 of the current and/or future vehicles for each transport phase alerting the environmental controller as to the desired environmental conditions for the cargo for that phase of transport. Optionally, the transport system 20 may communicate the transport plan to the device 110 of the cargo 100 which may, in turn, communicate with the environmental controller 104 for the present and any future phases of transport.

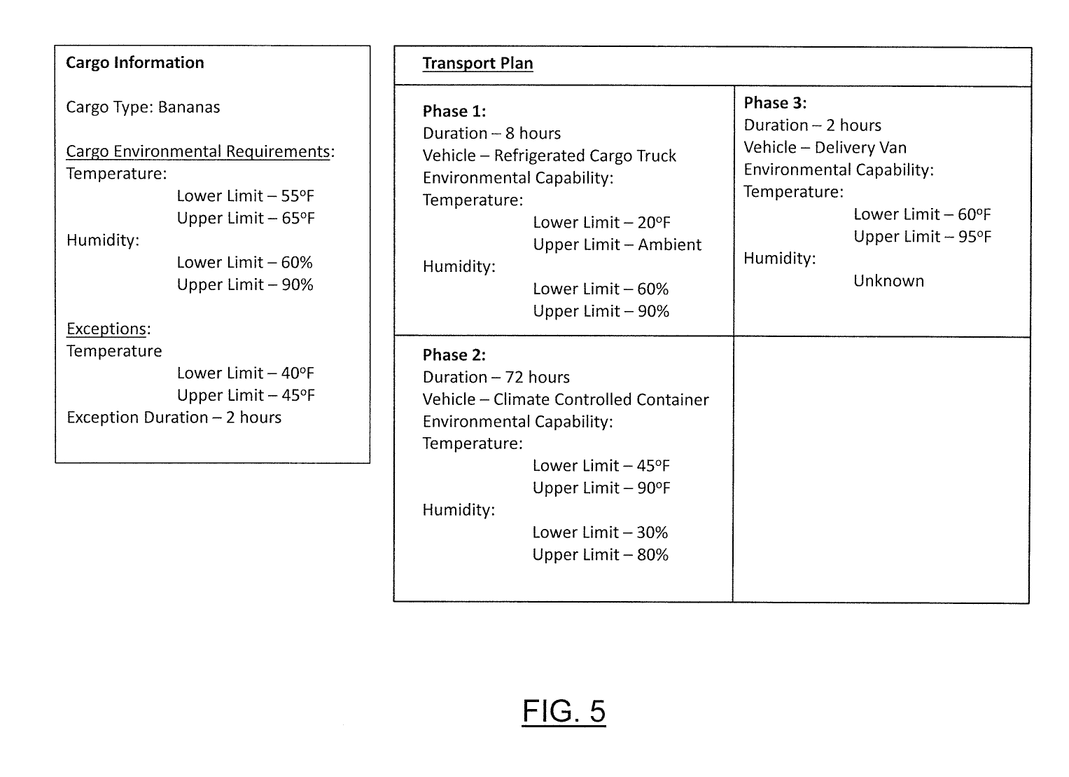

FIG. 5 illustrates an example of cargo information for a particular cargo type. The illustrated embodiment includes a cargo type of bananas, with specific environmental requirements. The environmental requirements include temperature to be between 55° F. and 65° F., with humidity levels controlled between 60% and 90%. The illustrated cargo type also includes an exception to the steady-state environmental controls. This exception is to hold the cargo at a low temperature (between 40° F. and 45° F.) for 2 hours. This exception may be, for example, a requirement for import as pest control (for example, the pests specific to the cargo may be killed in the exception temperature range), or as a requirement of the buyer, for ripening purposes.

FIG. 5 further illustrates the transport plan which includes three phases. This transport plan may be the transport plan generated at the origin as the anticipated transport plan for the cargo. The first phase includes transport via a refrigerated cargo truck for an anticipated duration of eight hours. The environmental capability of the refrigerated cargo truck may be known to have the capability to control temperatures to as low as 20° F., and relative humidity between 60% and 90%. Phase 2, which is illustrated to be a climate controlled container, which may be transported via truck or ship, may have different environmental capabilities, with a lower-limit of only 45° F. Phase 3 of the transport plan may include a shorter, two-hour anticipated duration with a lower temperature limit of only 60° F., and no known humidity control. The transport system 20 may interpret the capabilities of the vehicles of the various phases of the transport plan and plan a transportation itinerary accordingly.

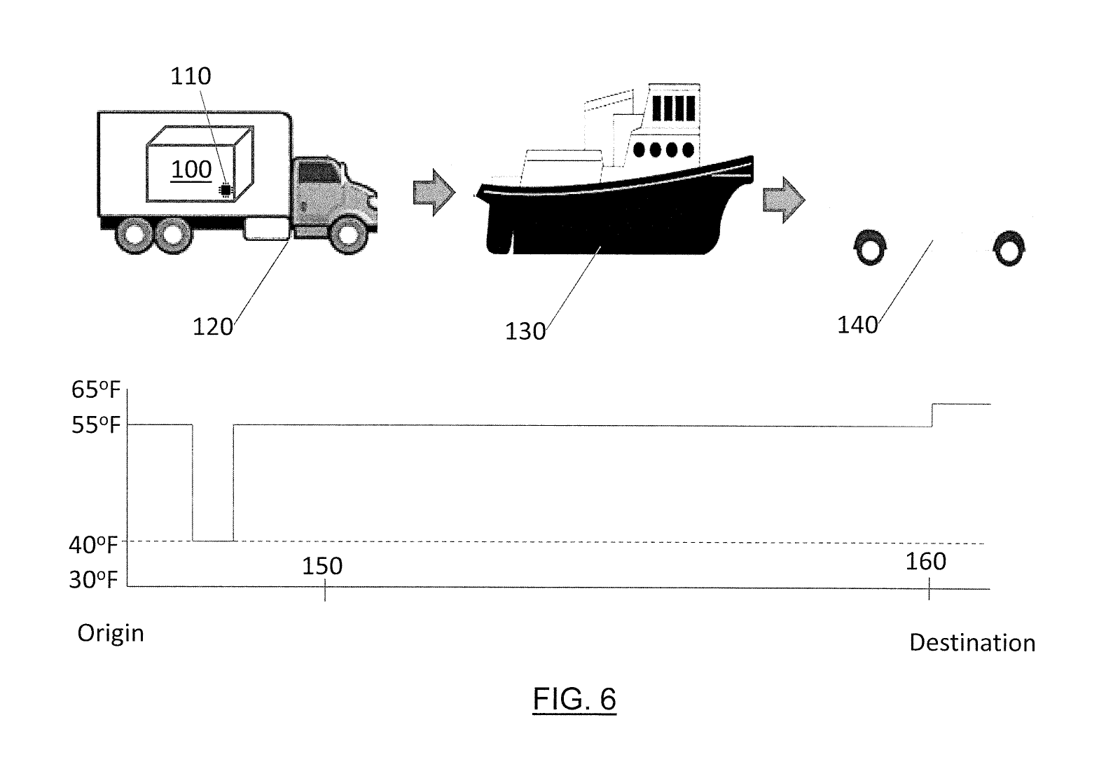

FIG. 6 illustrates the transport plan of FIG. 5 including the first phase of the cargo 100 carried by refrigerated cargo truck 120. As shown in the temperature timeline plan, the temperature during the first phase is held at 55° F. for the duration, except for two hours spent at 40° F., per the cargo environmental requirements. The transport plan may have determined that the phase of transport in which there is the best opportunity to reach the required 40° F.-45° F. exception temperature would be in the first phase, where the vehicle can control temperatures down to 20° F. The remaining phases do not have adequate temperature controls to meet the exception temperature. On the timeline at 150, the temperature is maintained at 55° F. when the cargo is transferred from the first phase to the second phase, in which the cargo is moved to a climate controlled container. Upon transfer from the second phase to the third phase at 160, the temperature plan is elevated to 60° F. since the cargo van of the third phase is not capable of lowering the temperature to 55° F.

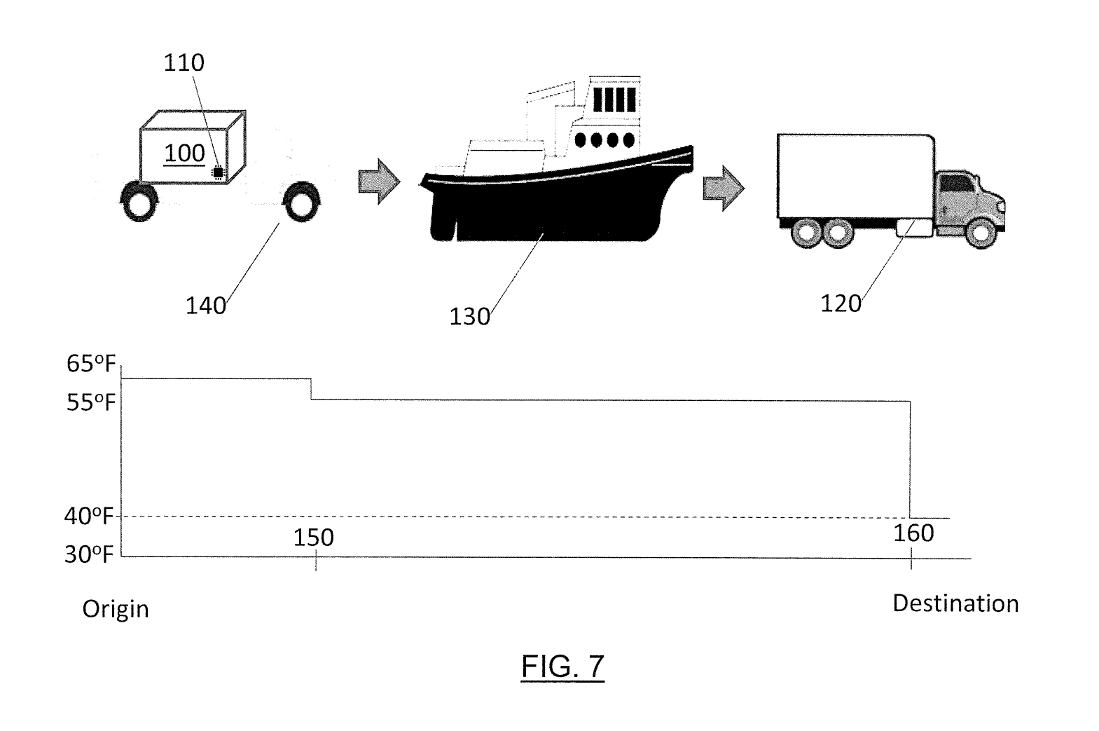

While the temperature timeline of FIG. 6 illustrates the planned temperature based on the transport plan and the various phases thereof, the transport plan of example embodiments may be dynamic in order to accommodate changes for unforeseen circumstances. FIG. 7 illustrates an example embodiment of a transportation plan that requires dynamic changes. While the cargo 100 may have the transport plan according to FIG. 5, at the origin, the vehicle arriving or available to transport the cargo in the first phase may be a cargo van that cannot control the environment below 60° F. Thus, the transport plan is dynamically updated to reflect this new limitation to the first phase. The transport plan may also alter the third phase requiring a refrigerated cargo truck to be available that is capable of controlling the environmental temperature down to the required 45° F. of the exception temperature.

According to various embodiments, changes to the transport plan may be communicated via wireless communication from the mobile device 110 to the transport system 20. The cargo 100 with mobile device 110 may be loaded into a vehicle for transport of phase one, and the mobile device may determine the vehicle into which it is loaded. For example, the vehicle may include a device, such as a radio-frequency identification (RFID) tag that identifies the vehicle and the environmental control capabilities of the vehicle. Upon detection, the mobile device 110 may communicate the vehicle information to the transport system 20 which may determine that the vehicle is the anticipated vehicle for the current phase, or that the vehicle is different and the transportation plan may require dynamic changes.

The mobile device 110 of the cargo 100 may further be capable of controlling the environment into which it is placed. For example, the mobile device 110 may determine the vehicle based on an identifier, such as the RFID tag noted above. The RFID tag may also provide instructions (for example, frequency of operation, control parameters, etc.) for controlling the environment of the vehicle. As such, the mobile device 110 may be placed into a vehicle and communicate to the environmental controls what temperature is necessary for the cargo. The environmental controls may respond through accommodating the requested temperature and/or other environmental parameters. In an instance in which multiple pieces of cargo are loaded into a vehicle and more than one includes a mobile device as described herein, each of the mobile devices may communicate their environmental requirements, and the environmental controls of the vehicle may accommodate those requests or provide a compromise that is acceptable (for example, within the permitted environmental ranges) to the cargo. Still further, some vehicles and containers may be capable of providing different environmental conditions to different areas of the vehicle or container. In such cases, the mobile device 110 may report environmental requirements and the location within the vehicle or container may be determined such that the area in which the cargo is located is controlled according to the requirements.

While FIG. 7 illustrates a transportation plan that is dynamically updated after the initial phase is altered, according to some embodiments, the transportation plan may be dynamically updated in the midst of the journey. For example, mobile device 110 may report to the transport system the environmental conditions experienced since the origin of the cargo. The environmental conditions may not be those which were anticipated during planned transport phases. For example, according to the embodiment of FIG. 7, cargo van 140 may have suffered a mechanical failure in a cold climate, and the cargo may have reached temperatures of 40° F. for more than two hours. While this environmental condition may be unplanned, the transport system 20 may recognize that the exception conditions for the cargo were met, such that the planned refrigerated cargo truck 120 for the third phase of the journey may no longer be required, and the temperature profile for the remainder of the journey may be to maintain the steady-state temperature of between 55° F. and 65° F.

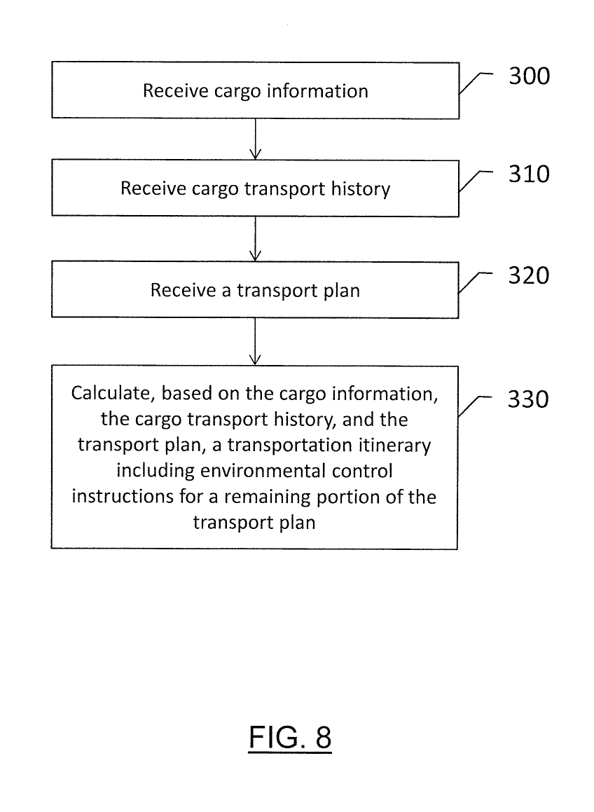

FIG. 8 is a flowchart illustrative of a system, method and program product according to example embodiments of the invention. The flowchart operations may be performed by a mobile terminal, such as mobile terminal 10 shown in FIG. 2, as operating over a communications network such as that shown in FIG. 1. It will be understood that each block of the flowcharts, and combinations of blocks in the flowcharts, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device of an apparatus employing an embodiment of the present invention and executed by a processor in the apparatus. As will be appreciated, any such computer program instructions may be loaded onto a computer or other programmable apparatus (for example, hardware), such as depicted in FIG. 2, to produce a machine, such that the resulting computer or other programmable apparatus embody means for implementing the functions specified in the flowchart block(s). These computer program instructions may also be stored in a computer-readable memory that may direct a computer or other programmable apparatus to function in a particular manner, such that the instructions stored in the computer-readable memory produce an article of manufacture the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart block(s).

Accordingly, blocks of the flowchart support combinations of means for performing the specified functions, combinations of operations for performing the specified functions and program instruction means for performing the specified functions. It will also be understood that one or more blocks of the flowchart, and combinations of blocks in the flowcharts, can be implemented by special purpose hardware-based computer systems which perform the specified functions, or combinations of special purpose hardware and computer instructions.

An example embodiment of a method for dynamically updating a transportation plan of is depicted in the flowchart of FIG. 8. According to the depicted method, cargo information may be received at 300. The cargo information may include a cargo type, such as a type of produce, animal products, electronic equipment, etc. A cargo transport history may be received at 310. The cargo transport history may include an environmental profile of the transport phases that have already occurred and/or portions of the transport journey that lack environmental monitoring information. The history may be more granular for certain types of products, such as meat or dairy products where environmental controls may be more important for safety. A transport plan may be received at 320, where the transport plan includes a destination and may include one or more remaining phases of transport between the current location of the cargo and the destination. At 330, a transportation itinerary including environmental control instructions for a remaining portion of the transport plan (for example, one or more transport phases) may be calculated based on the cargo information and the cargo transport history. The environmental history of the cargo may be used to help determine or change the remaining environmental control requirements for remaining phases of the transport journey.

In an example embodiment, an apparatus for performing the method of FIG. 8 above may comprise a processor (for example, the processor 40) configured to perform some or each of the operations (300-330) described above. The processor may, for example, be configured to perform the operations (300-330) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 300-330 may comprise, for example, the processor 40 and/or a device or circuit for executing instructions or executing an algorithm for processing information as described above.

As described above and as will be appreciated by one skilled in the art, embodiments of the present invention may be configured as a system, method or electronic device. Accordingly, embodiments of the present invention may be comprised of various means including entirely of hardware or any combination of software and hardware. Furthermore, embodiments of the present invention may take the form of a computer program product on a computer-readable storage medium having computer-readable program instructions (for example, computer software) embodied in the storage medium. Any suitable computer-readable storage medium may be utilized including hard disks, CD-ROMs, optical storage devices, or magnetic storage devices.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. An apparatus comprising at least one processor and at least one memory including computer program code, the at least one memory and the computer program code configured to, with the at least one processor, cause the apparatus to at least:
receive, from a wireless communication device, cargo information identifying cargo comprising one or more items of cargo;
identify, based on the cargo information, a cargo type of the cargo, a current location of the cargo, and a destination for the cargo;
map, based on the identified cargo type, the cargo to a handling information profile comprising cargo environmental requirements; and
determine a transport itinerary, based on at least the cargo environmental requirements, the current location, and the destination, wherein the transport itinerary comprises a plurality of travel phases for the cargo, wherein each of the travel phases are determined to include a mode of transportation and environmental control instructions related to the mode of transportation.

2. The apparatus of claim 1, wherein the cargo information comprises environmental transport history information.

3. The apparatus of claim 1, wherein the apparatus is further caused to at least:
receive cargo transport history comprising environmental conditions experienced during one or more prior travel phases of the plurality of travel phases; and
determine, based on the handling information profile for the cargo, whether an environment exception condition occurred during the one or more prior travel phases.

4. The apparatus of claim 3, wherein the cargo transport history comprises an environmental history of the cargo beginning at an origin of the cargo.

5. The apparatus of claim 4, wherein the apparatus is further caused to at least:
calculate, based on at least the cargo transport history, future environmental requirements for a travel phase occurring after the one or more prior travel phases, the future environmental requirements comprising environmental control instructions that differ from the determined transport itinerary.

6. The apparatus of claim 1, wherein the environmental control instructions differ between at least two phases of the plurality of travel phases.

7. The apparatus of claim 1, wherein the environmental control limitations of a first phase of the plurality of travel phases influence the environmental control instructions for a second phase of the plurality of travel phases.

8-20. (canceled)

21. A method comprising:
receiving, from a wireless communication device, cargo information identifying cargo comprising one or more items of cargo;
identifying, based on the cargo information, a cargo type of the cargo, a current location of the cargo, and a destination for the cargo;
mapping, based on the identified cargo type, the cargo to a handling information profile comprising cargo environmental requirements; and
determining a transport itinerary, based on at least the cargo environmental requirements, the current location, and the destination, wherein the transport itinerary comprises a plurality of travel phases for the cargo, wherein each of the travel phases are determined to include a mode of transportation and environmental control instructions related to the mode of transportation.

22. The method of claim 21, wherein the cargo information comprises environmental transport history information.

23. The method of claim 21, further comprising:
receiving cargo transport history comprising environmental conditions experienced during one or more prior travel phases of the plurality of travel phases; and
determining, based on the handling information profile for the cargo, whether an environment exception condition occurred during the one or more prior travel phases.

24. The method of claim 23, wherein the cargo transport history comprises an environmental history of the cargo beginning at an origin of the cargo.

25. The method of claim 24, further comprising:
calculating, based on at least the cargo transport history, future environmental requirements for a travel phase occurring after the one or more prior travel phases, the future environmental requirements comprising environmental control instructions that differ from the determined transport itinerary.

26. The method of claim 21, wherein the environmental control instructions differ between at least two phases of the plurality of travel phases.

27. The method of claim 21, wherein the environmental control limitations of a first phase of the plurality of travel phases influence the environmental control instructions for a second phase of the plurality of travel phases.

28. A non-transitory computer-readable medium encoded with instructions that, when executed by at least one processor, cause operations comprising:
receiving, from a wireless communication device, cargo information identifying cargo comprising one or more items of cargo;
identifying, based on the cargo information, a cargo type of the cargo, a current location of the cargo, and a destination for the cargo;
mapping, based on the identified cargo type, the cargo to a handling information profile comprising cargo environmental requirements; and
determining a transport itinerary, based on at least the cargo environmental requirements, the current location, and the destination, wherein the transport itinerary comprises a plurality of travel phases for the cargo, wherein each of the travel phases are determined to include a mode of transportation and environmental control instructions related to the mode of transportation.

29. The non-transitory computer-readable medium of claim 28, wherein the cargo information comprises environmental transport history information.

30. The non-transitory computer-readable medium of claim 28, wherein the operations further comprise:
receiving cargo transport history comprising environmental conditions experienced during one or more prior travel phases of the plurality of travel phases; and
determining, based on the handling information profile for the cargo, whether an environment exception condition occurred during the one or more prior travel phases.

31. The non-transitory computer-readable medium of claim 30, wherein the cargo transport history comprises an environmental history of the cargo beginning at an origin of the cargo.

32. The non-transitory computer-readable medium of claim 31, further comprising:
calculating, based on at least the cargo transport history, future environmental requirements for a travel phase occurring after the one or more prior travel phases, the future environmental requirements comprising environmental control instructions that differ from the determined transport itinerary.
